(19) United States
(12) Patent Application Publication
(10) Pub. No.: US 2004/0081939 A1
(43) Pub. Date: Apr. 29, 2004

(54) Dental device

(76) Inventor: Otto Rosenstatter, Seeham (AT)

Correspondence Address: WENDEROTH, LIND & PONACK, L.L.P., 2033 K STREET N. W., SUITE 800, WASHINGTON, DC, 20006-1021, US

(21) Appl. No.: 10/322,709

(22) Filed: Feb. 24, 2003

(30) Foreign Application Priority Data
Dec. 20, 2001 (AT) GM 963/2001

(51) Int. Cl. A61C 1/08; A61C 3/00

(52) U.S. Cl. 433/126; 433/29; 433/85

(57) ABSTRACT

Dental instrument, with a handpiece (15) housing a driven tool (5), which handpiece is rotatably connected to a supply device (28) by a tube (14) containing lines.

### DESCRIPTION

The invention relates to a dental instrument, with a handpiece housing a driven tool, which handpiece is connected to a supply device by a tube containing lines:

Customarily, air and water flow through dental handpieces to form a spray. In addition, there are proposals to run an image conductor along the handpiece in order to be able to photograph the operative field. In order that this measure is practical, the area of interest must be illuminated, which is achieved by optical conductors connected to the handpiece. The motor connected to the handpiece requires an energy supply in the form of compressed air or electrical energy.

In order that the dentist can rotate the handpiece about its longitudinal axis, adaptor rotary couplings are customarily provided for the various lines between the handpiece and the motor casing or between the motor casing and a [supply device] securely connected at the end of the tube. As the number of medium and signal lines increases, it becomes ever more difficult to design a well-functioning rotary coupling of the type described. The invention renders rotary couplings superfluous in the region of the handpiece by providing that the tube is connected rotatably to the supply device. There is sufficient space there for developing the rotary coupling.

In order that the dentist is not hindered by the torsional resistance of the tube when rotating the handpiece, it is preferably provided that a drive for rotating the tube is provided in the supply device. The dentist therefore only needs to initiate the desired rotational movement, as is customary for steering motor vehicles, and the drive provided in the supply device provides the torque necessary for rotating the tube. There are sufficient examples in the state of the art of the implementation of this idea in a design. In this specific case, it is advantageously provided that for controlling the drive, two switches are provided which can be operated by a swivelling part, which is housed in a casing that is connected to the tube in a rotation-resistant manner.

As an unusually large number of lines can be run to the tool holder due to the rotatable tube and the attachments laid into the supply device, in a preferred version lines for reading information affixed to the tool are also run in the handpiece. These are in particular formed by two information storage rings which contain information on the speed as well as on the torque of the tool.

Further details of the invention are explained in the following with reference to the drawing.

There are shown in

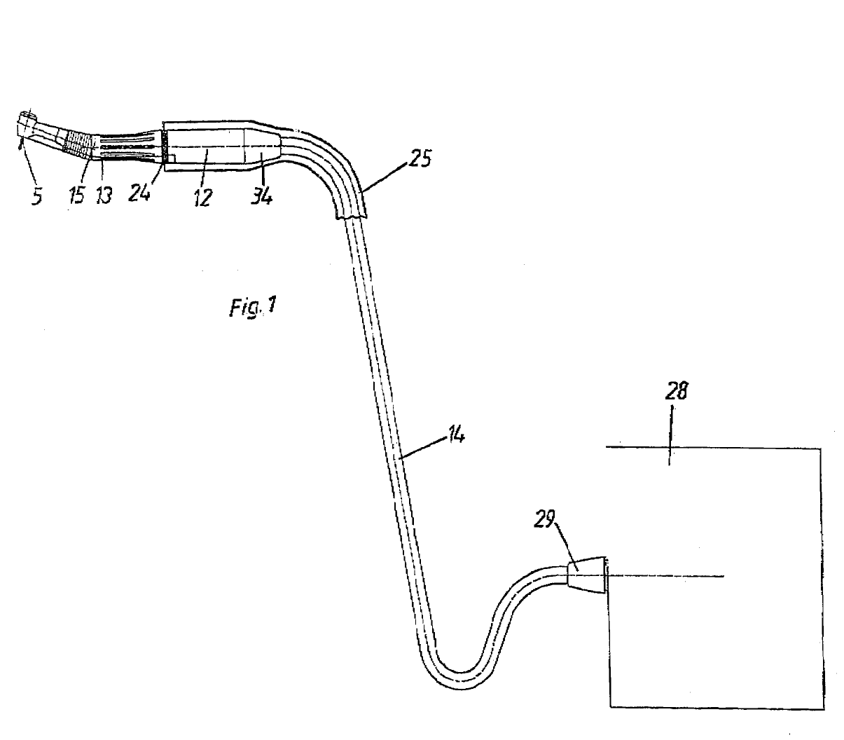

FIG. 1 the overall representation of an embodiment,

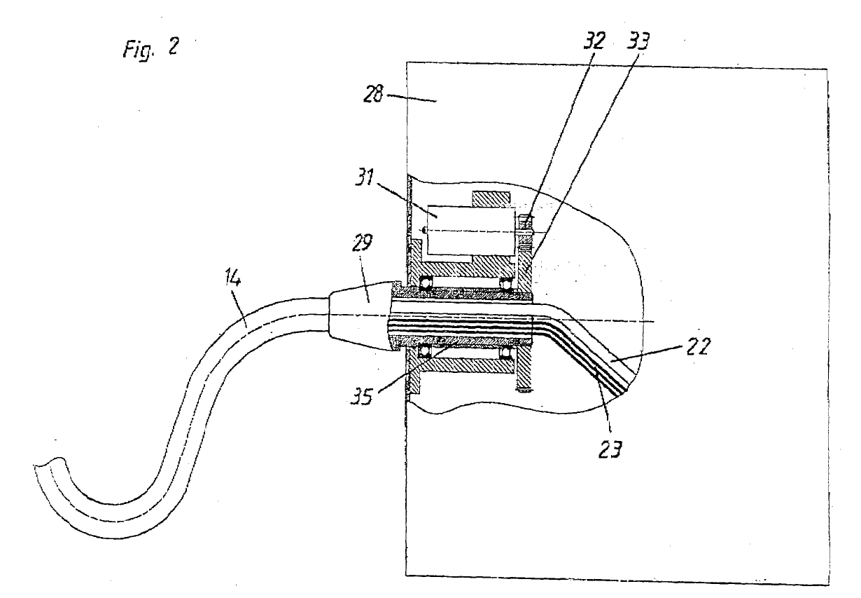

FIG. 2 an enlargement of the right-hand part in FIG. 1, partially in section,

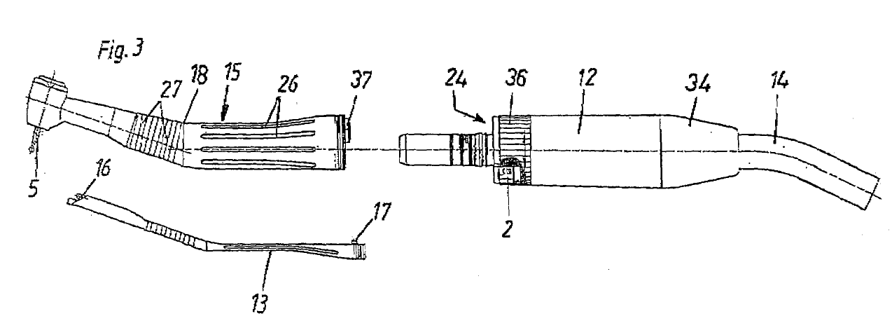

FIG. 3 a representation of the parts of the left-hand side of FIG. 1,

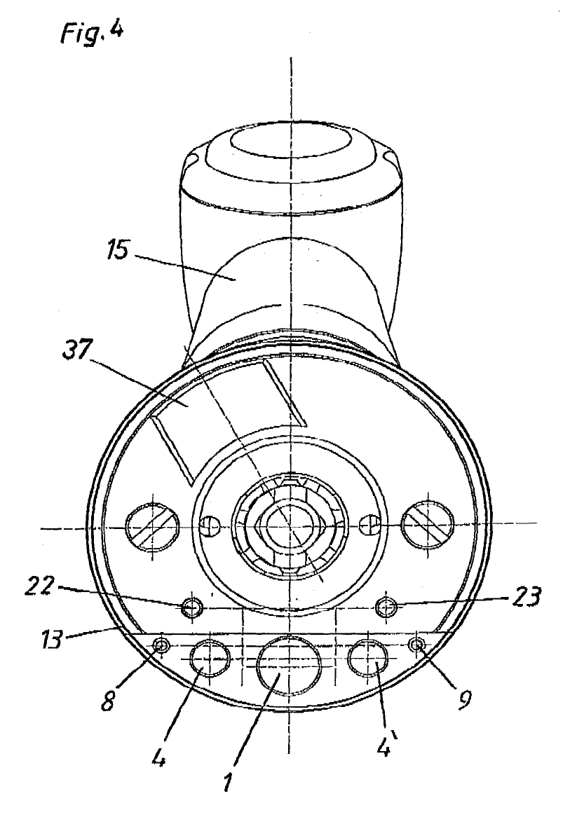

FIG. 4 a view of the interface between the handpiece and the motor casing in the direction of the handpiece,

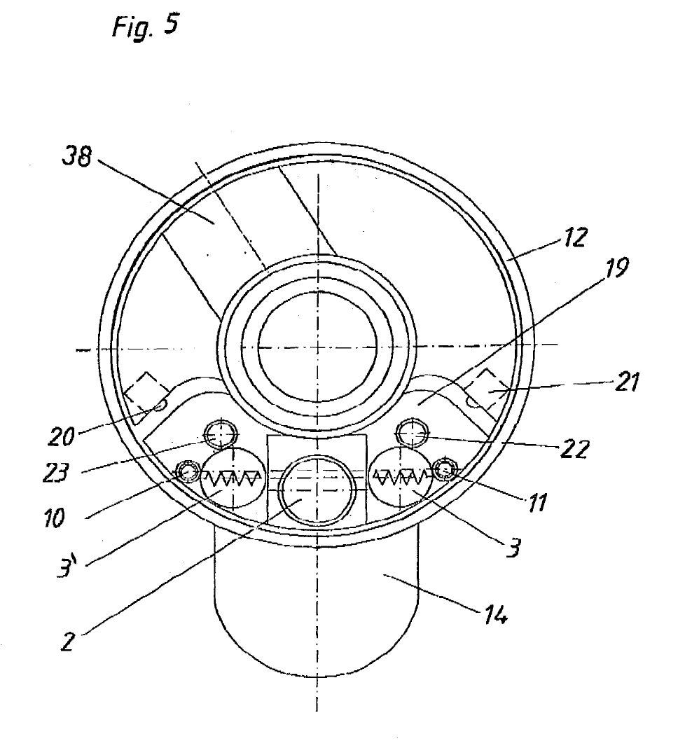

FIG. 5 a representation corresponding to FIG. 5 in the direction of the motor casing,

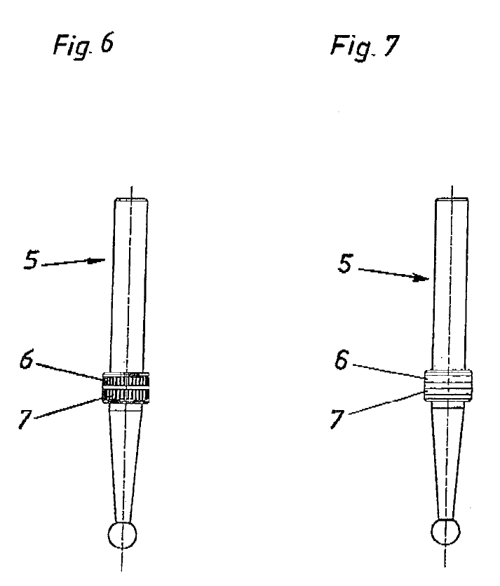

FIG. 6 and 7 two representations of a tool, and

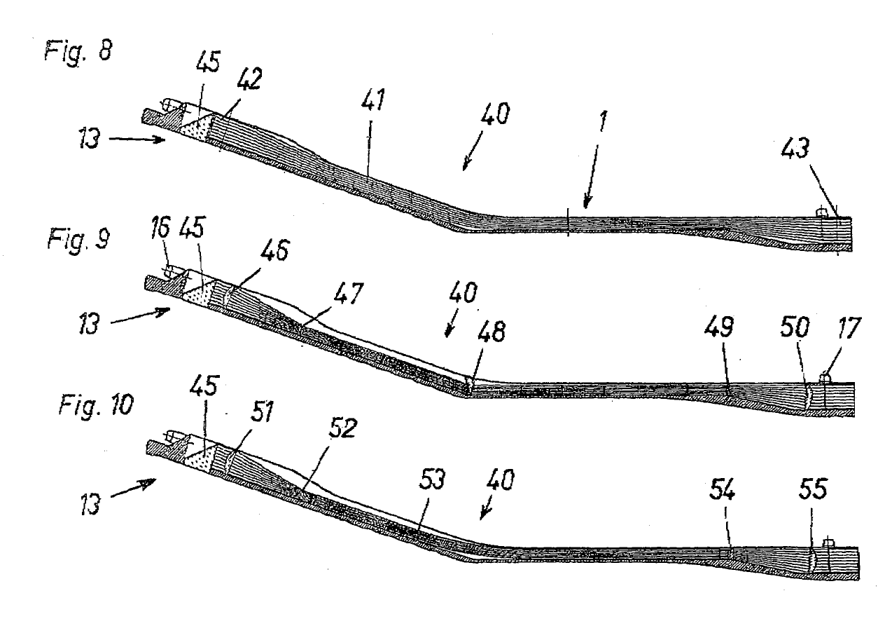

FIG. 8 to 10 longitudinal sections cut through three different versions of the line carrier shown in FIG. 3.

The dental instrument represented in FIG. 1 comprises as its main components a casing 12 for housing a motor which is not represented and a handpiece 15 for housing a treatment tool 5, for example a drill. In order to supply the motor with energy and to return signals from the preparation point, lines, in particular for air and water, are provided in a twist-resistant tube 14. The tube 14 is connected in a rotation-resistant manner to a casing 12 via an attachment piece 34. As FIG. 2 shows, a socket attachment 29 connects the tube 14 to the supply device 28. It is essential to the invention that this connection is rotatable, which is achieved by making the sleeve 35, which is connected to the tube 14 and which comprises inter alia the lines 22, 23 for air and water, rotatably housed.

The casing 12 for the motor and the handpiece 15 are separable from each other, which is of considerable practical importance: if a thin plastic tube 25 is clamped into the interface 24 between these two elements, it is sufficient to autoclave the handpiece 15 and the treatment tool 5 after each treatment. On the other hand, the casing 12 and the tube 14 are protected by the plastic tube 25 which is discarded after the treatment and replaced by a new plastic tube.

FIG. 3 shows how the handpiece 15 is separable along the interface 24 from the casing 12 which contains the drive for the tool 5 and a CCD camera 2. Fixed to the casing 12 is a rotatable regulating ring 36, the twisting of which moves the CCD camera axially and thus adjusts the focus. A line carrier 13, which in the operational state is connected to the handpiece 15 by means of the nose 16 and the magnet 17, is removable from the handpiece 15. This line carrier has longitudinal grooves 26 in order that the doctor can hold the instrument in a rotation-resistant manner. The cross grooves 27 provide an axial support for the hand. The grooves 26 and 27 are developed such that they can be freed of coarse dirt by movement in one direction. The removability of the line carrier 13 allows it to be sterilized other than by autoclaving, for example by chemical disinfectants.

FIG. 4 shows that the line 22 for the air and the line 23 for the water are run in the handpiece 15 in order to produce a cooling spray mist. There is located in the removable line carrier 13 an image conductor 1 which leads from the treatment site to the CCD camera 2, as well as optical conductors 4 and 4′ which illuminate this treatment site. Furthermore, there are arranged in the line carrier 13 lines 8 and 9, the function of which is explained later with reference to FIG. 6 and 7.

FIG. 8 to 10 show longitudinal sections through the image conductor 1 in three different versions of the removable line carrier 13. According to FIG. 8, the image conductor 1 is formed by a fibre-optic conductor 41 which has a circular cross-section at a prism 45 at the entry 42 as well as at the exit 43 to the CCD camera 2, and has in contrast an oval cross-section in the intermediate section 40 spanning the kink 18 in the handpiece 15.

FIG. 9 shows a version in which the image beam reflected by around 90° by the entry prism 45 is reduced in diameter by the downstream lenses 46 and 47.

The reduced image beam is directed by a reflection prism 48 allocated to the kink 18 of the handpiece 1 5 onto a further pair of lenses 49 and 50 which opens the image beam again and guides it on to the CCD camera 2.

FIG. 10 shows a combination of the two versions of FIG. 8 and 9. Here too, the image beam is reflected by around 90° in the entry prism 45 and reduced in diameter by a pair of lenses 51 and 52. There is connected to the lens 52 a thin fibre-optic conductor 53 which guides the image beam over the intermediate section 40 spanning the kink 18 of the handpiece 15 to the second pair of lenses 54, 55. This opens the image beam again to the size necessary for the CCD camera 2.

The lines 22 and 23 run through the handpiece continue by means of socket connections in the swivelling part 19 which is housed in the casing 12, as can be seen from FIG. 5. The optical conductors 4, 4′ of the handpiece 15 end before incandescent lamps 3, 3′ arranged in the swivelling part 19. The image conductor 1 opens into the CCD camera 2 which for its part guides the converted signals via the tube 14 to the supply device 28. The image data can also be transmitted in a contactless manner by radio onto a screen or the like.

If the dentist twists the handpiece 15 slightly, the swivelling part 19 follows this movement. However, the torque required to twist the casing 12 and the tube 14 is produced not by the dentist's hand, but by the motor 31 which can be seen in FIG. 2. This is achieved by the fact that a slight twisting of for example 5° of the swivelling part 19 is transmitted to the switch 20 or 21 and via a signal line triggers a rotation of the motor 31 in the appropriate rotation direction. By means of the toothed wheels 32 and 33, this motor rotates the sleeve 35 and therefore the tube 14, so that the dentist need only trigger, but not carry out, the rotation. The tube 14 therefore follows the movement of the dentist synchronously through the whole angle range of 360°.

The particular advantage of the version according to the invention is that the critical transition of the lines from the rotatable to the fixed part from the too small and filigree area of the handpiece 15 or of the casing 12 is run rearwards to the end of the connecting tube, i.e. to a point at which there is normally much more space for the housing and sealing off of the individual elements. The number of lines run through by the instrument or the handpiece can therefore be made unusually great.

In particular, it is thereby also possible to provide one information storage ring each for the maximum permissible speed 6 and for the maximum permissible torque 7 at the tool 5 as represented in FIG. 6 and 7 and to feed the information stored there via additional lines 8, 9 through the handpiece to an evaluation device. The information on speed and torque can for example, as shown in FIG. 6, be provided in each case as a barcode on the rings 6, 7; however, other possibilities are also conceivable, for example that the relevant information is stored in a magnet (FIG. 7), a transponder, a storage film or an electronic paper.

In order to read the two barcodes for the speed 6 and the torque 7, fibre-optic conductors are preferably run through the handpiece as additional lines 8, 9, via which the resulting laser signals are guided to Hall sensors 10, 11 in the swivelling part 19 of the casing 12. There they are converted into electric signals which appropriately control the motor arranged in the casing 12 via the electronics arranged in the supply device 28.

Speeds between 0 and ca. 300,000 to 400,000 revolutions can be contained in the information storage rings 6, 7. The same applies to the torque. With these two pieces of information or with the system information built up from speed and torque, many drill producers which are located worldwide and are in competition can sell drills in the present worldwide distribution system without consultation and agreement with the respective device manufacturers.

As, when using the two new pieces of information, the dentist himself does not have to set either the speed or the torque according to the drill used, his involvement is reduced to mere switching on and off. This can be carried out advantageously in a contactless manner (voice dialling), so that no sterilization problems occur with the supply device.

For the rotation-resistant connection between the handpiece 15 and the casing 12, there is provided in the casing 12 a recess 38 into which a projection 37 of the handpiece 15 engages. The recess 38 is larger in the peripheral direction than the projection 37, so that the slight twisting required for connecting the motor 31 is maintained. The recess 38 also allows conventional handpieces to be attached without a line carrier.

1. Dental instrument, with a handpiece housing a driven tool, which handpiece is connected to a supply device by a tube containing lines, characterized in that the tube (14) is connected rotatably to the supply device (28).

2. Dental instrument according to claim 1, characterized in that in the supply device (28) a drive (31) is provided to rotate the tube (14).

3. Dental instrument according to claim 2, characterized in that there are provided for controlling the drive (31) two switches (20, 21) which can be operated by a swivelling part (19) which is housed in a casing (12) connected in a rotation-resistant manner to the tube (14).

4. Dental instrument according to claim 3, characterized in that the swivelling part (19) is detachable with the handpiece (15), but is connected in a rotation-resistant manner.

5. Dental instrument according to claim 4, characterized in that a sleeve (25) surrounding the casing (12) and the tube (14) can be securely clamped between the handpiece (15) and the casing (12) housing a motor.

6. Dental instrument according to one of claims 1 to 5, characterized in that the handpiece (15) is provided with longitudinal grooves (26).

7. Dental instrument according to one of claims 1 to 6, characterized in that lines (8, 9) for reading information affixed to the tool (5) are run in the handpiece (15).

8. Dental instrument according to claim 7, characterized in that information storage rings (6, 7) are provided at the tool (5), information on the speed being stored in the ring (6) and information on the torque in the ring (7).

9. Dental instrument according to one of claims 1 to 8, characterized in that the handpiece (15) contains a removable line carrier (13).

10. Dental instrument according to claim 9, characterized in that the line carrier (13) contains lines (1, 3, 3′, 4, 4′, 22 and 23) which are provided for transmitting image data, light and tool information.
